(19) United States
(12) Patent Application Publication
(10) Pub. No.: US 2002/0140826 A1
(43) Pub. Date: Oct. 3, 2002

(54) Photographing apparatus, a method for controlling recording of a moving picture or a still picture, and an image editing apparatus

(76) Inventors: Kazuchika Sato, Kobe-Shi (JP); Masahito Niikawa, Sakai-Shi (JP); Noriyuki Okisu, Osakasayama-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/102,477

(22) Filed: Mar. 20, 2002

(30) Foreign Application Priority Data
Mar. 28, 2001 (JP) 2001-094066

(51) Int. Cl. H04N 5/225

(52) U.S. Cl. 348/222.1

(57) ABSTRACT

In an inventive electronic camera, when a recording button is pressed down, the name of a moving picture file corresponding to a moving picture to be recorded and the name of a folder in which this moving picture is to be saved are set, and recording of the moving picture file is started or continued. As a start button is pressed down to photograph a still picture during recording of the moving picture file, the name of a still picture file is set, an instruction is given to store the still picture file in the same folder as the moving picture folder is saved, and a connection information including a frame number of the moving picture corresponding to this still picture file is generated or renewed.

This application is based on patent application No. 2001-94066 filed in Japan, the contents of which are hereby incorporated by references.

### BACKGROUND OF THE INVENTION

This invention relates to a photographing apparatus, a method for controlling recording of a moving picture or a still picture, and an image editing apparatus.

In conventional moving picture photographing apparatuses, a moving picture is photographed as successive still images and a corresponding moving picture data is generated and recorded. Compression such as MPEG is applied to the moving picture data for the purpose of reducing the data size and increasing the processing speed. Actually, even if the moving picture reproduced from these moving picture data looks finely, still images individually extracted have rough image qualities. Even if these still images are printed out, they are not worth seeing.

A technique of a photographing apparatus which meets a request to photograph a still picture of high quality upon having a best scene simultaneously with recording of a moving picture is known from Japanese Unexamined Patent Publication Nos. 2000-352759 and 11-308488.

An electronic camera disclosed in the publication No. 2000-352759 and a video camera disclosed in the publication No. 11-308488 are constructed such that a still picture of high quality is recorded when a shutter start button is pressed during recording of a moving picture. Thus, a photographer does not miss a good shutter-start timing even during recording of the moving picture.

However, the above conventional moving picture photographing apparatuses do not sufficiently consider handling of the photographed moving picture and still pictures.

Particularly, the above electronic camera does not assume its versatile use such as editing of the recorded moving picture and still pictures. Users felt inconvenient and confused without understanding a connection between the moving picture and the still picture recorded during recording of the moving picture when arranging and searching the pictures for use.

Further, in the above video camera, the recording time of the still picture in a memory card during recording of the moving picture in a video tape is recorded, and the still picture is displayed for a specified period based on the recorded timing while the moving picture is reproduced on a display screen. However, this video camera does not assume the use of the moving picture and the still pictures.

### SUMMARY OF THE INVENTION

It is an object of the present invention to provide a photographing apparatus, a method for controlling recording of a moving picture or a still picture, and an image editing apparatus which are free from the problems residing in the prior art.

According to an aspect of the invention, a still picture is photographed upon a photographing instruction given during recording of a moving picture. There are recorded a moving picture file corresponding to the recorded moving picture, a still picture file corresponding to the photographed still picture, and an information recording part which records a connection information indicating a correspondence between a section of the moving picture corresponding to a time of the photographing instruction and the still picture.

A folder is generated in a specified storage for each moving picture as the moving picture is recorded. The moving picture file is saved in the generated folder. Also, the still picture file is saved in the generated folder.

Still images which are frame images of a moving picture are edited using a memory storing a moving picture file, and a connection information file storing a connection information indicating a predetermined correspondence between a specified still picture and a specific one of the still images. A connection information on an edited specific still image of the connection information file is renewed when the specific still image is edited.

These and other objects, features and advantages of the present invention will become more apparent upon a reading of the following detailed description and accompanying drawings.

### BRIEF DESCRIPTION OF THE DRAWINGS

FIG. 1 is a front diagrammatic view showing an external configuration of an electronic camera according to an embodiment of the present invention;

FIG. 2 is a block diagram showing a construction of the electronic camera;

FIG. 3 is a diagram showing recording of a moving picture and still picture files as a shutter start button and a recording button are pressed down;

FIG. 4 is a diagram showing a configuration of a file to be recorded in a memory card;

FIGS. 5A, 5B and 5C are diagrams showing rules in setting names of a moving picture file and a still picture file generated by the electronic camera, respectively;

FIG. 6 is a table showing an example of a connection information file indicating correspondences between a moving picture file and still picture files;

FIG. 7 is a flowchart showing a procedure of an image recording routine;

FIG. 8 is a diagram showing a configuration of a moving picture/still picture joint file to be recorded in an electronic camera according to another embodiment of the present invention;

FIG. 9 is a table showing a configuration of a header area of the moving picture/still picture joint file;

FIG. 10 is a front diagrammatic view showing an external configuration of an image editing apparatus according to still another embodiment of the invention;

FIG. 11 is a block diagram showing a hardware construction of the image editing apparatus;

FIG. 12 is a diagram showing a correspondence between a moving picture file and a still picture file to be edited by the image editing apparatus;

FIG. 13 is a table showing a connection information file generated by the electronic camera as the moving picture file and the still picture file of FIG. 12 are generated;

FIG. 14 is a table showing an example of a renewed connection information file as a result of editing;

FIG. 15 is a flowchart showing a procedure of a moving picture file edition routine accompanied by a change in the connection information file;

FIGS. 16A and 16B are tables showing examples of other renewals of the connection information file of FIG. 13; and

FIG. 17 is a flowchart showing a procedure of a still picture file edition routine accompanied by a change in the connection information file.

### DETAILED DESCRIPTION OF THE PREFERRED EMBODIMENTS OF THE PRESENT INVENTION

An electronic camera and an image editing apparatus for editing moving picture and still pictures recorded by the electronic camera in accordance with embodiments of the invention are described with reference to the accompanying drawings.

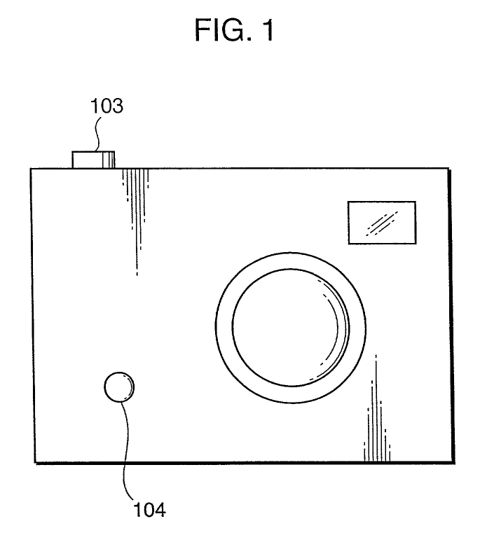

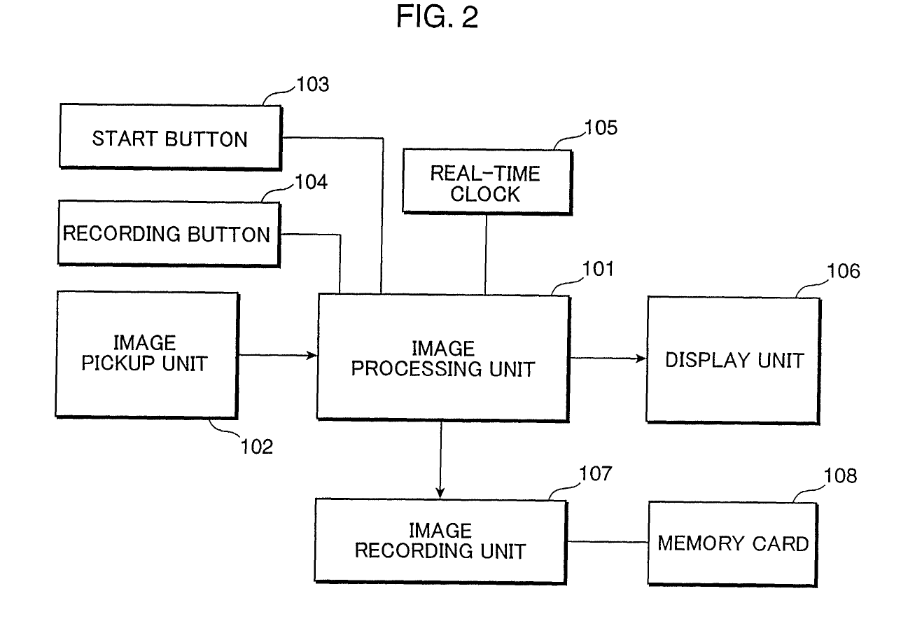

Referring to FIGS. 1 and 2, an electronic camera is operable to photograph a still picture at a good shutter-start timing simultaneously with recording of moving picture, and is provided with a display unit 106 on the rear surface for displaying a subject image photographed as a moving picture or a still picture, an image pickup unit 102, an image processing unit 101, and an image recording unit 107. The image pickup unit 102 generates an analog image signal from a subject image and outputs a digital image data obtained by converting this analog image signal to the image processing unit 101 in accordance with a control by the image processing unit 101 as a shutter start button 103 or a recording button 104 is pressed down. The image processing unit 101 controls the entire electronic camera and applies specified processings to the image data outputted from the image pickup unit 102. The image recording unit 107 applies an image compression such as MPEG or JPEG to the image data processed in the image processing unit 101 and records the resulting image data in a memory card 108.

More specifically, the image pickup unit 102 includes a CCD sensor. In the image pickup unit 102, after correlative double sampling (CDS) and automatic gain control (AGC) are applied to an analog image signal obtained by the CCD sensor, analog-to-digital conversion is applied thereto to generate an image of a specified bit length. The image processing unit 101 includes a CPU, ROM, RAM, etc., applies interpolation, γ-correction, and outlining to the image data generated by the image pickup unit 102 and outputs the processed image data to the image recording unit 107 while controlling the image pickup unit 102 and the image recording unit 107.

In this electronic camera, by turning an unillustrated power button on, a moving picture is photographed by the processings of the image processing unit 101 and the image recording unit 107, and a subject image is displayed as a moving image on the display unit 106. Upon pressing the recording button 104 down, a moving picture file (e.g., MPEG-format) corresponding to the displayed subject image is generated in the memory card 108, that is, moving picture is recorded. On the other hand, upon pressing the start button 103 down, still pictures are picked up at timings during a recording period and a non-recording period and a still picture file (e.g., JPEG-format) and still picture files are generated in the memory card 108 by the processings of the image processing unit 101 and the image recording unit 107.

A real-time clock 105 is adapted to generate a specified time information to be added to these moving picture file and still picture file.

It should be noted that in the block diagram of FIG. 2, the respective blocks are shown according to their functions, but each block is not necessarily required to be a separate unit. These blocks may be constructed by individual mechanisms, circuits, etc. or a plurality of blocks may be constructed by a common mechanism or circuit. The function of a single block may also be fulfilled by cooperation of a plurality of mechanisms and circuits. Further, a part of a plurality of blocks or a part of each block may be realized as function of at least one processor or a program to be executed by a CPU. Furthermore, the respective blocks may be realized by a combination of the above constructions as a matter of course.

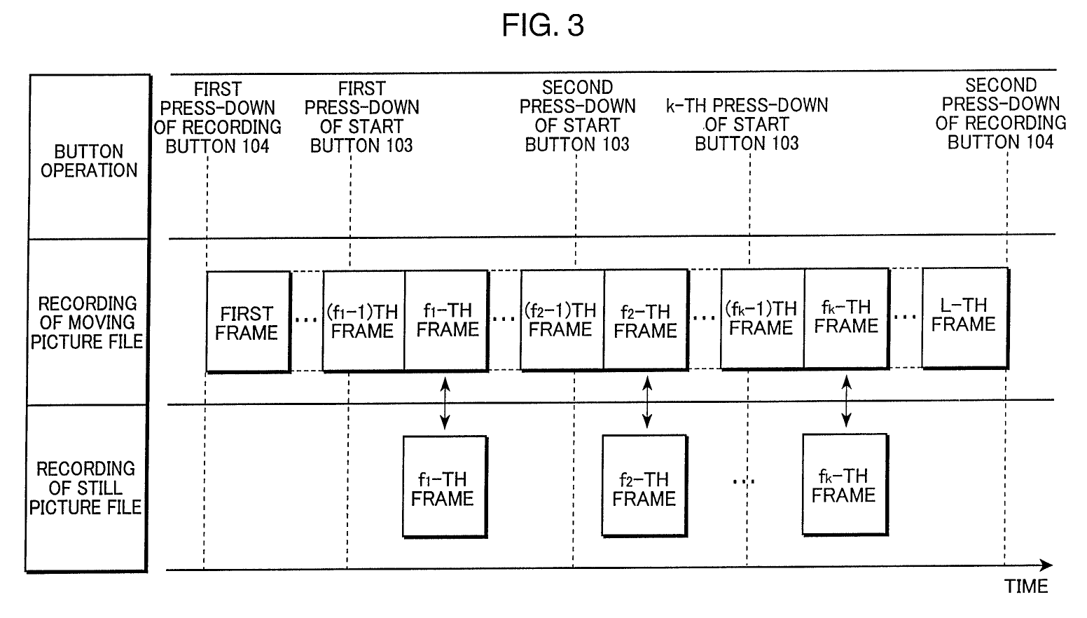

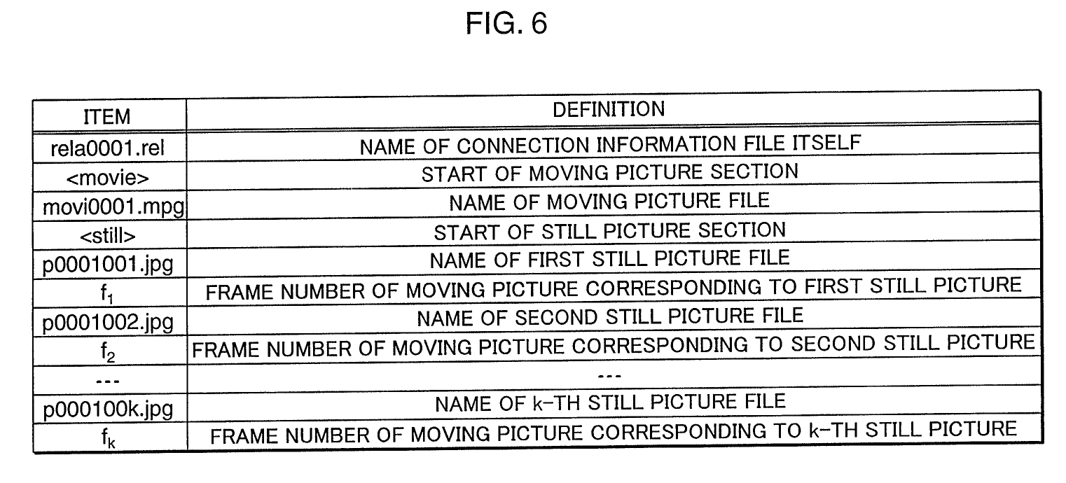

In this electronic camera, firmware including a program for an image recording routine to be described later in the ROM of the image processing unit 101 is executed by the CPU; the moving picture file and the still picture file are recorded as shown in FIGS. 3 to 5B as the still pictures are photographed during recording of the moving picture; and a connection information file indicating a correspondence between the moving picture file and the still picture file as shown in FIG. 6 is recorded.

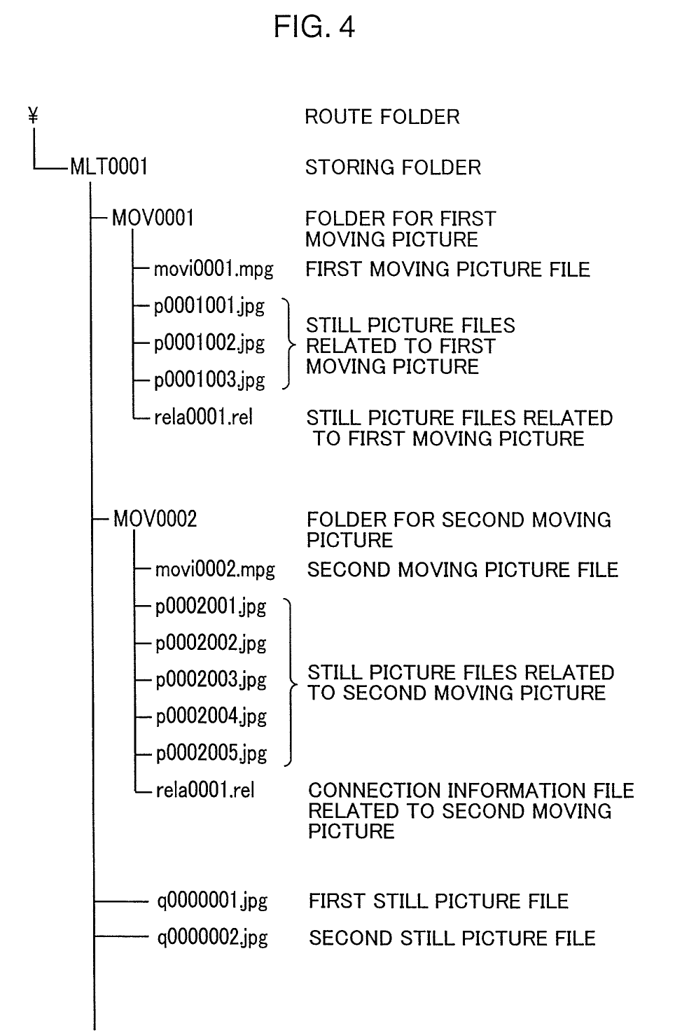

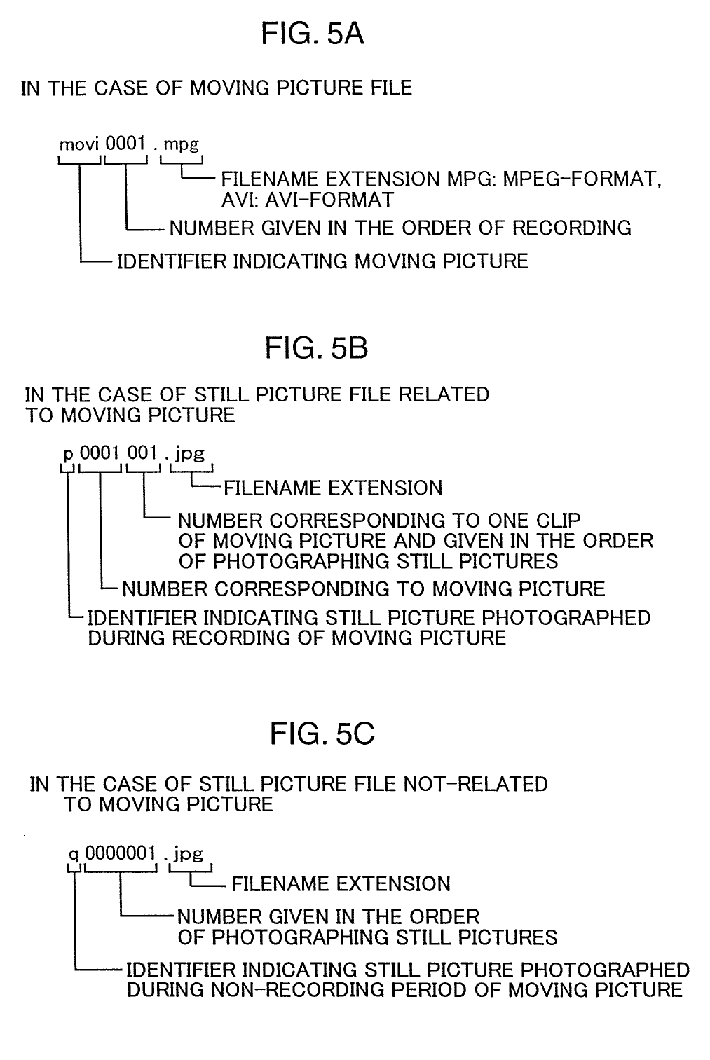

FIG. 3 is a diagram showing recording of the moving picture file and the still picture file as the start button 103 and the recording button 104 are pressed down, FIG. 4 is a diagram showing a configuration of a file to be recorded in the memory card 108, and FIGS. 5A, 5B and 5C are diagrams showing rules in setting names of the moving picture file and the still picture file generated by the electronic camera.

As shown in FIG. 3, recording of the moving picture file is started when the recording button 104 is pressed down for the first time, whereby still images are recorded frame by frame at specified time intervals (e.g., intervals of 1/30 sec.) as a first frame image, a second frame image, . . . , an L-th frame image forming the moving picture until recording of the moving picture file is completed by pressing the recording button 104 down for the second time.

If it is assumed that the start button 103 is pressed down when a (f₁−1)th frame image, a (f₂−1)th frame image, . . . , a (fₖ−1)th frame image are picked up during recording of a moving picture, still pictures corresponding to a f₁-th frame, a f₂-th frame, . . . , a fₖ-th frame are picked up and the respective still picture files are recorded. In fact, a specified file system is used in the memory card 108, and the moving picture file and the still picture files are recorded in a hierarchized folder as shown in FIG. 4.

In FIG. 4, for example, a folder “MOV0002” corresponding to a second moving picture to be recorded in the memory card 108 is generated below a storing folder “MLT0001” which is set beforehand for saving all moving picture files and still picture files as recording of the second moving picture is started, and a second moving picture file “movi0002.mpg” corresponding to the second moving picture is saved in this folder “MOV0002”. If the start button 103 is successively pressed down five times during recording of the second moving picture, still pictures corresponding to the respective timings when the start button 103 is pressed down are photographed, and still picture files “p0002001.jpg”, “p0002002.jpg”, “p0002003.jpg”, “p0002004.jpg” and “p0002005.jpg” are successively saved.

More specifically, as shown in FIG. 5A, the name of the moving picture file includes an identifier (“movi” in FIG. 5A) indicating the moving picture, a clip number or number “0001” given in the order of recording of the moving picture in the memory card 108 which number is so renewed as to increase or decrease by one every time the moving picture file is generated, and a filename extension (“mpg”, “avi”, etc.) in conformity with a compression format.

The name of the still picture file differs depending on whether or not it has a connection with the moving picture.

In the case of the still picture file having a connection with the moving picture, the name thereof includes, as shown in FIG. 5B, an identifier (“p”) indicating a still picture picked up during recording of the moving picture, a number (“0001”) corresponding to a series of moving picture being recorded, a number corresponding to one clip of moving picture and successively given in the order of recording the still pictures, “001”, which is so renewed as to increase or decrease by one every time the still picture file is generated during recording of one clip of moving picture, and a filename extension (“jpg”) in conformity with a compression format.

In the case of the still picture file having no connection with the moving picture, the name thereof includes, as shown in FIG. 5C, an identifier (“q”) indicating a still picture picked up during a non-recording period of the moving picture, a number given in the order of recording still pictures while no moving picture is recorded, “0000001”, indicating the number of still pictures recorded in the memory card 108, and a filename extension (“jpg”).

Particularly, the still picture files having a connection with the moving picture are saved in folders (“MOV0001”, “MOV0002”) corresponding to the respective moving picture in the storing folder (“MLT0001” of FIG. 4), whereas those having no connection with the moving picture are saved right below the storing folder.

When these still pictures are picked up, a connection information file as shown in FIG. 6 is recorded in the folder corresponding to each moving picture file. The connection information file to be recorded includes the name of the moving picture file “movi0001.mpg”, the file name “p0001001.jpg” of the first still picture picked up as the start button 103 is pressed down for the first time during recording of the moving picture and a frame number “f₁” of the corresponding moving picture, the file name “p0001002.jpg” of the second still picture and a frame number “f₂” of the corresponding moving picture, . . . , and the file name “p000100k.jpg” of the k-th still picture and a frame number “fₖ” of the corresponding moving picture. Pieces of information on the respective still pictures are added every time the still picture is picked up.

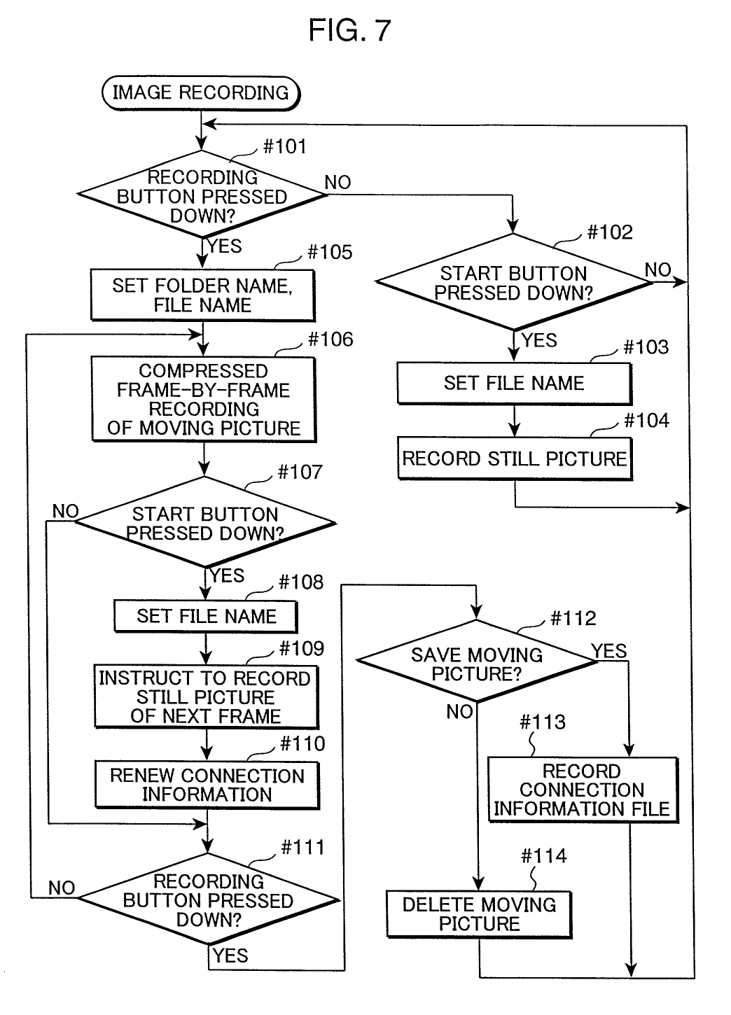

Next, an image recording routine of recording these moving picture file and still picture file is described in detail. FIG. 7 is a flowchart showing a procedure of the image recording routine.

In the image recording routine, when the start button 103 is pressed down (YES in Step #102) while the recording button 104 (see FIGS. 1 and 2) is left unpressed (NO in Step #101), the name of the still picture file is set (Step #103), that is, the file name such as “q0000001.jpg” is set in accordance with the rules shown in FIG. 5, and an instruction is given to the image recording unit 107 to record the still picture file in the memory card 108 (Step #104). After the operation in Step #104, this routine is returned to Step #101 and waits on standby until the recording button 104 or the start button 103 is pressed down.

When the recording button 104 is pressed down (YES in Step #101), the folder name such as “MOV0001” corresponding to the moving picture and the file name such as “movi0001.mpg” are set (Step #105); the frame-by-frame compressed recording of the moving picture is instructed to the image recording unit 108 (Step #106); and it is discriminated whether the start button 103 has been pressed down during recording of this moving picture (Step #107).

When the recording button 103 is pressed down (YES in Step #107), the name of the still picture file is set (Step #108), that is, the file name such as “p0001001.jpg” is set in accordance with the rules shown in FIG. 5. An instruction is given to record a still image of a frame f₁ next to a frame (f₁−1), shown in FIG. 3, to be recorded at a timing when the start button 103 is pressed down (Step #109). After the recorded connection information is renewed or generated (Step #110), this routine proceeds to Step #111. Unless the start button 103 is pressed down (NO in Step #107), this routine proceeds to Step #111 without performing operations in Step #108 to #110.

Unless the recording button 104 is pressed down to instruct an end of recording (NO in Step #111), this routine returns to Step #106. If the recording button 104 is pressed down (YES in Step #111), an input to instruct whether or not the moving picture is to be saved is received via an operation button or the like provided near the display unit 106 while making a specified display on the display unit 106, and it is discriminated whether saving of the moving picture has been instructed (Step #112).

If saving of the moving picture is instructed (YES in Step #112), the connection information generated in the RAM is recorded as a connection information file in the memory card 108 (Step #113) and this routine returns to Step #101. Unless saving of the moving picture is instructed (NO in Step #112), the moving picture file recorded in the memory card 108 is deleted (Step #114) and this routine returns to Step #101.

As described above, in this electronic camera, as an instruction is given to photograph a still picture during recording of the moving picture, the corresponding moving picture file and still picture file are recorded in the memory card 108, and the connection information concerning a correspondence between the still picture files generated as an exposure is made a plurality of times during recording of one moving picture and the frame numbers of the moving picture corresponding to the respective exposures is temporarily generated in the RAM and recorded in the connection information file.

Since the moving picture and still pictures are recorded in the conventional filing format (MPEG-format, JPEG-format, etc.) and they are corresponded to each other by the connection information in the connection information files, the user can easily know the correspondence between the frames of the moving picture and the still pictures by, for example, referring to the connection information using a specified image editing apparatus, and can conveniently edit the moving pictures and the still pictures.

Further, in the above electronic camera, no connection information file is generated when only the still pictures are recorded or an instruction is given not to save the moving picture, thereby eliminating useless operations.

Particularly, by saving the moving picture file, still picture files generated by the exposures during recording of the moving picture and related to the moving picture stored in the moving picture file, and the connection information files indicating connections between the moving picture file and the still picture files in one folder of the memory card and further by setting the names of the moving picture file, the still picture files related to the moving picture, the still picture files not related to the moving picture and the connection information files in accordance with the rules as shown in FIG. 5, the user can easily discriminate whether or not there is any connection between the moving picture and the still pictures and how many still pictures correspond to one moving picture when, for example, editing the moving picture and the still pictures later on using a specified image editing apparatus, with the result that he can more conveniently arrange, search, administer the files.

Although any of the moving picture file, the still picture file and the connection information file is assumed to be recorded in the memory card in the above electronic camera, it may be assumed to record them in an other recording medium such as a hard disk or a magneto-optic disk provided in the electronic camera or to recorded them separately in a plurality of different recording mediums.

Further, in the above electronic camera, as the start button is pressed down, the connection information is renewed and the connection information file storing the corresponding connection information is saved in response to the succeeding instruction to save the moving picture file. However, the connection information files may be successively renewed together with the connection information as the start button is pressed down, and the connection information files may be deleted upon the instruction not to save the moving picture file.

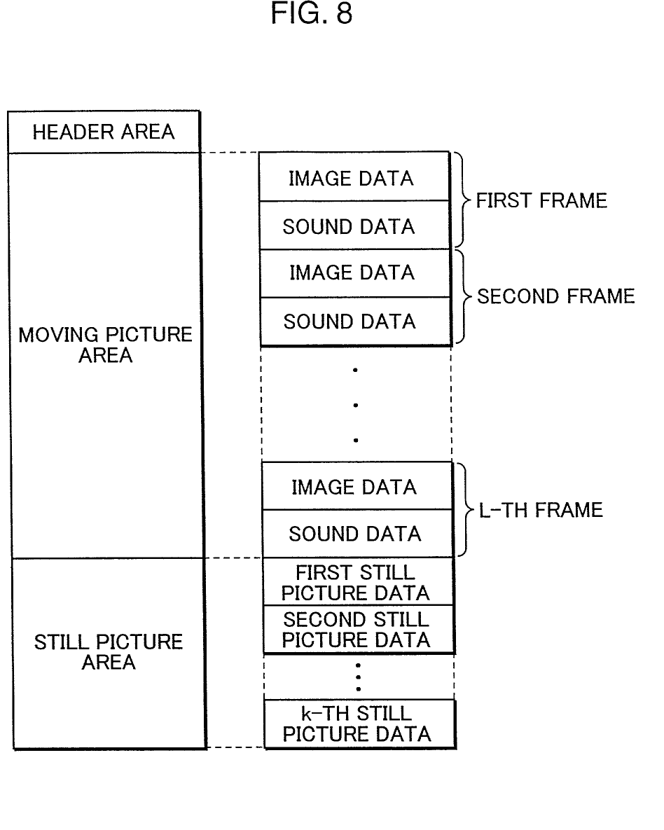

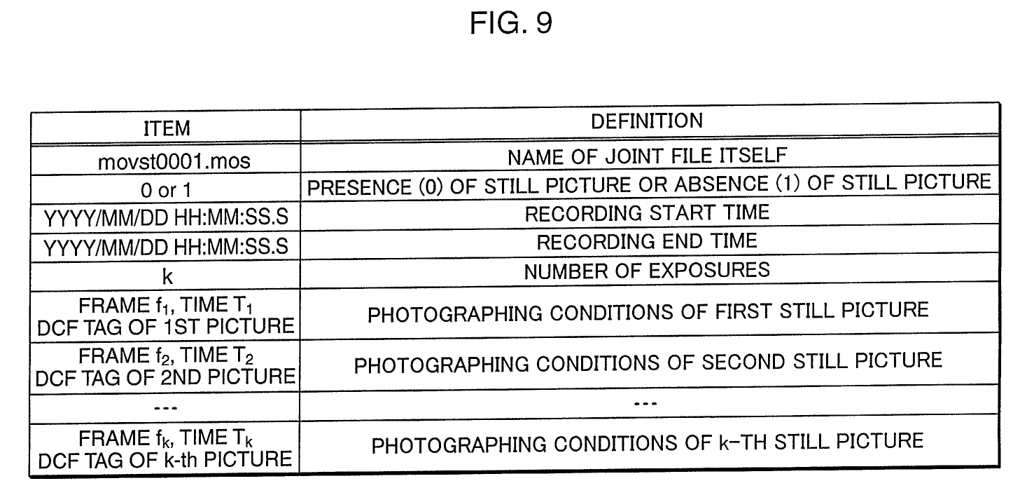

Next, an electronic camera according to another embodiment of the invention is described. FIG. 8 is a diagram showing a configuration of a moving picture/still picture joint file to be recorded in the electronic camera according to this embodiment, and FIG. 9 is a table showing a configuration of a header area of the moving picture/still picture joint file. The electronic camera of this embodiment is constructed and operates as the above electronic camera except the file configuration described below.

As shown in FIG. 8, the moving picture/still picture joint file to be recorded in the electronic camera of this embodiment includes a header area, a moving picture area and a still picture area. These three areas correspond to the connection information file, the moving picture file and the still picture file of the above electronic camera. An image data and a sound data are generated frame by frame at intervals of 1/30 sec., and are saved in the moving picture area. It can be assumed to be recorded in a format similar to AVI-format. Further, the still picture area is renewed to store a still picture data generated as the start button is pressed down during recording of one moving picture. If the start button is pressed down “k” times, the still picture area includes a first still picture data, a second still picture data, . . . , a k-th still picture data.

As shown in FIG. 9, recording start time and end time of one moving picture, the number of exposures made to photograph still pictures during recording of the moving picture, and photographing conditions corresponding to the respective still pictures are recorded in the header area of the moving picture/still picture joint file. The recording start time and end times are recorded in 1/10 sec.unit. More specifically, the photographing conditions include the frame numbers of the moving picture corresponding to the still picture, relative photographing times or periods between the starting time of recording of the moving picture and the times of the exposures, which periods are calculated based on time measurement by the real-time clock 105, and DCF tags corresponding to the respective still pictures, and an attribute as to whether or not the joint file has a still picture area, that is, whether or not the still pictures were photographed during recording of the moving picture. The term “DCF” stands for design rule for camera file system. A DCF tag includes a photographing time based on time measurement, a shutter speed, an aperture value information, etc.

The header area of the above moving picture/still picture joint file can indicate a correspondence between the moving picture and the still pictures as the aforementioned connection information file indicating the correspondence between the moving picture file and the still picture file does.

Although the connection information is recorded as part of the moving picture/still picture joint file in the electronic camera of this embodiment, it may be recorded as part of the moving picture file or the still picture file.

Further, although one set of CCD sensor is used in the image pickup unit in the foregoing embodiments, one set of CCD sensor for picking up moving picture and one set of CCD sensor for picking up still pictures may be separately provided, so that the moving picture and the still pictures can be picked up at independent timings. Then, frames of the moving picture recorded temporally close to the exposure timings and having similar images can be corresponded to the still pictures.

Next, an image editing apparatus for editing the moving picture files and the still picture files thus recorded in the memory card 108 are described.

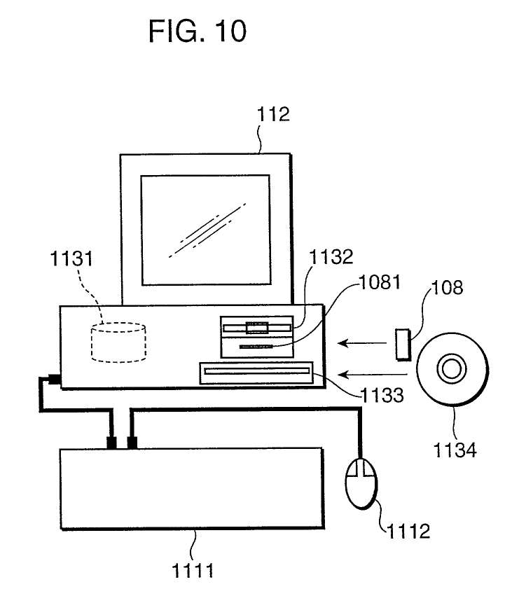

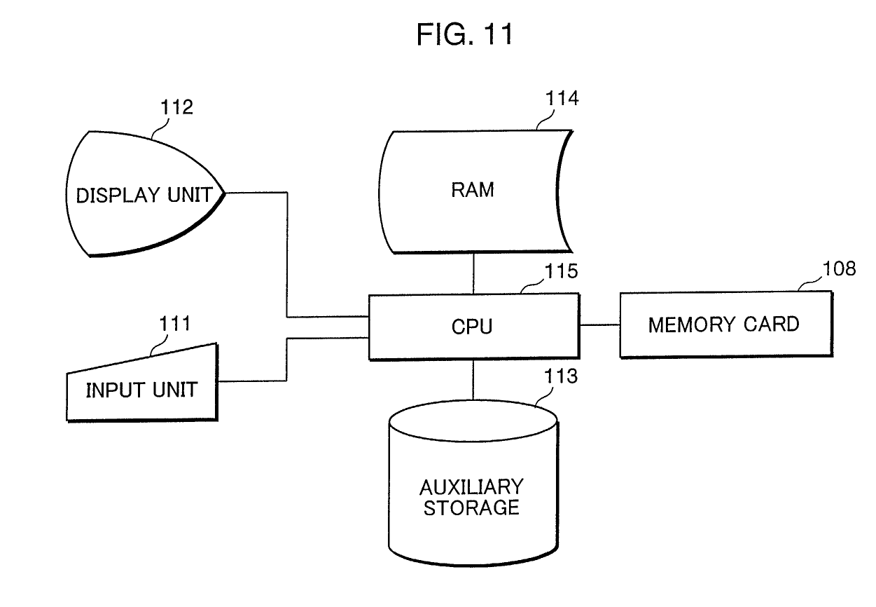

FIG. 10 is a front diagrammatic view showing an external configuration of an image editing apparatus according to one embodiment of the invention, and FIG. 11 is a block diagram showing a hardware construction of the image editing apparatus.

This image editing apparatus is a normally used computer, and is provided with an input unit 111 including a keyboard 1111 and a mouse 1112 and adapted to receive an input from a user, a display unit 112 for making a display for the user, an auxiliary storage unit 113 including a hard disk 1131, a floppy disk drive 1132, a CD-ROM drive 1133 for recording a program file, etc., a RAM 114 for temporarily saving a program and data to be used, and a central processing unit (CPU) 115 for executing the loaded program in the RAM 114 while controlling the input unit 111, the display unit 112, the auxiliary storage unit 113, etc.

In this image editing apparatus, files including moving picture files, still picture files and connection information files can be written in and read from a memory card 108 inserted into a memory card slot 1081, and programs including a moving picture file edition program and a still picture file edition program to be described later saved in the CD-ROM 1134 can be installed in the HDD1131.

In this image editing apparatus, by the execution of the moving picture file editing program and the still picture file editing program, the user can edit the frames of the moving picture stored in the moving picture files and the still pictures stored in the still picture files in the memory card 108. This image editing apparatus is characterized in renewal of the connection information files as the frames of the moving picture and the still pictures are edited.

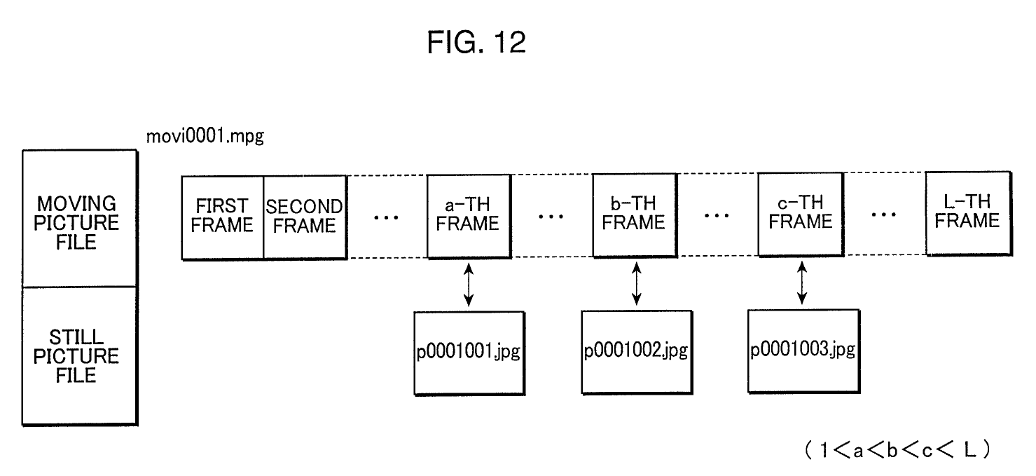

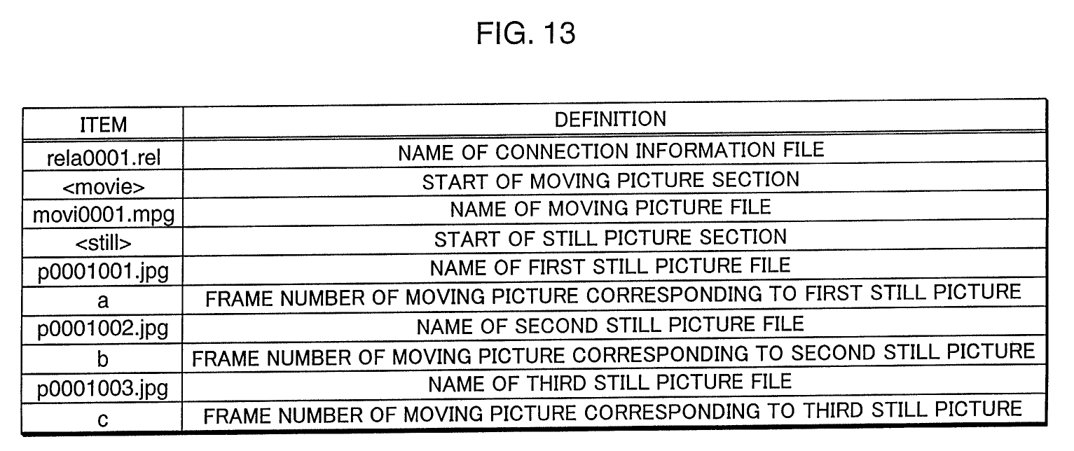

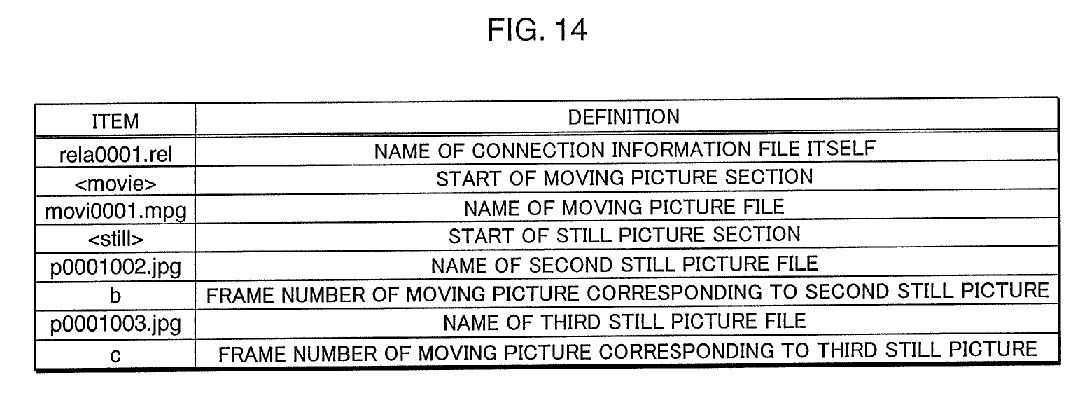

FIG. 12 is a diagram showing a correspondence between a moving picture file and a still picture file to be edited by the image editing apparatus, FIG. 13 is a table showing a connection information file generated by the electronic camera as the moving picture file and the still picture file of FIG. 12 are generated, and FIG. 14 is a table showing an example of a renewed connection information file as a result of editing.

FIG. 12 shows that frames “a”, “b”, “c” of a moving picture file “movi0001.mpg” correspond to a first still picture “p0001001.jpg”, a second still picture “p0001002.jpg” and a third still picture “p0001003.jpg”, respectively. These correspondences are defined in the connection information file shown in FIG. 13.

If the frame “a” or consecutive frames including the frame “a” of the moving picture is assumed to be edited in the image editing apparatus, the connection information corresponding to the edited still picture is deleted from the connection information file and is renewed as in a connection information file shown in FIG. 14. In fact, it can be confirmed in the connection information file of FIG. 14 that “p0001001.jpg” and “a” are deleted from the items in the table of FIG. 13.

Since the correspondence between the moving picture and the still picture is eliminated by the renewal of the connection information file, “p” in the name “p0001001.jpg” of the first still picture file is changed to “q” and a name obtained by adding 1 to the maximum number (see FIG. 5C) among the names of the still picture files saved immediately under the storing folder is newly set as the name of the first image file.

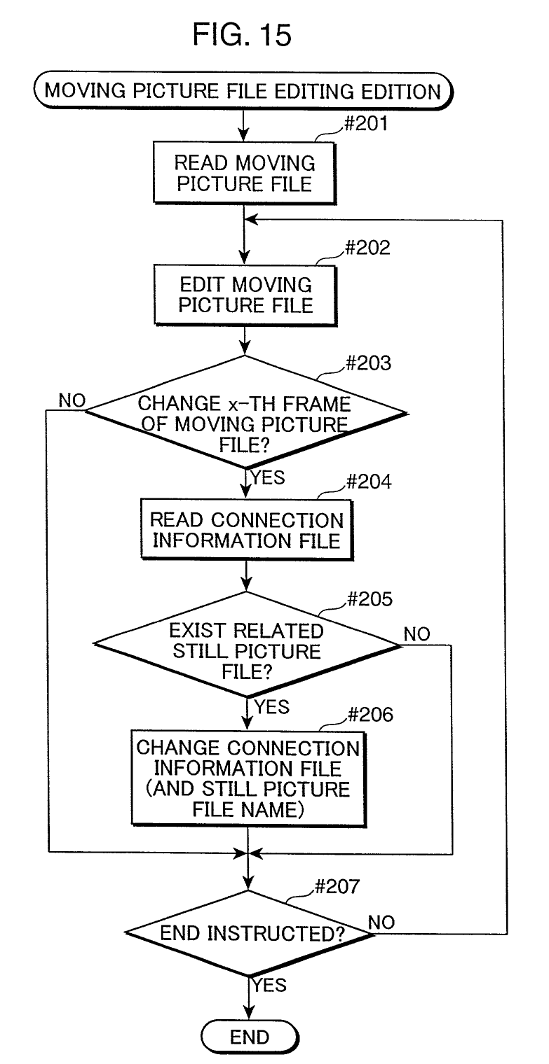

FIG. 15 is a flowchart showing a procedure of a moving picture file editing routine accompanied by a change in the connection information file.

In the moving picture file editing routine, the moving picture file recorded in the memory card 108 is read (Step #201) and editing of the moving picture file is received (Step #202).

When it is detected that an x-th frame of the moving picture has been changed by a user(Step #203), the connection information file is read (Step #204) and it is discriminated whether there is any still picture file corresponding or related to the x-th frame, or whether “x” is included in the frame number written in the connection information file (Step #205).

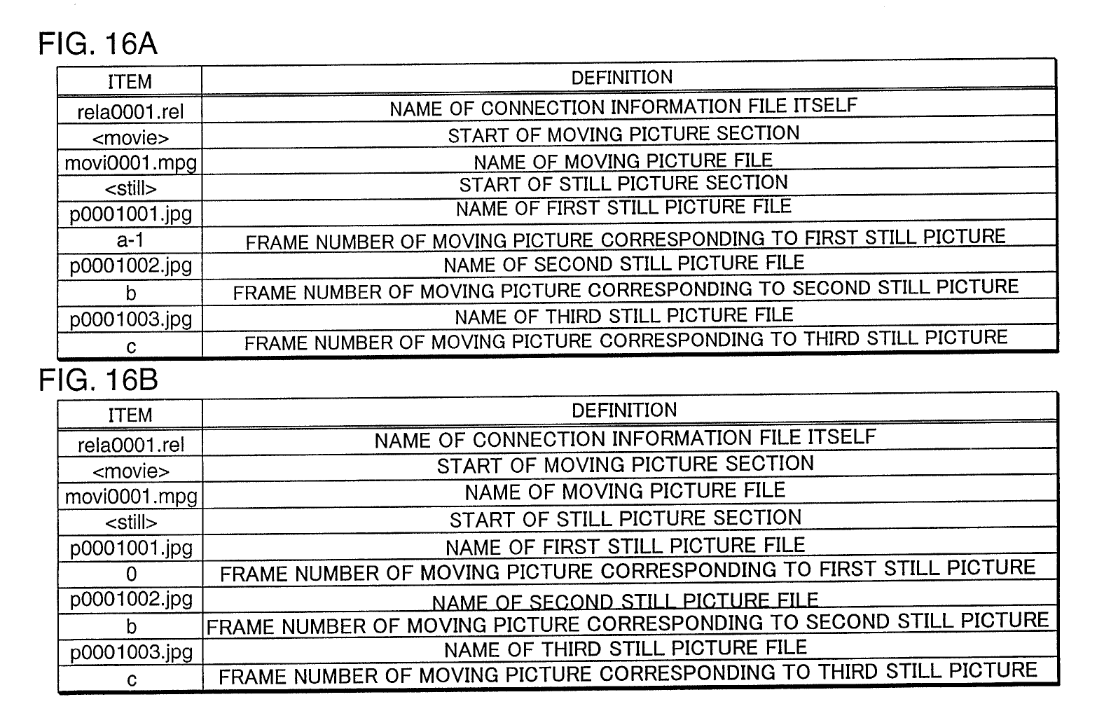

If there is a still picture file corresponding to the x-th frame (YES in Step #205), the connection information file is changed as shown in FIGS. 14 and 16 or the name of the still picture file is changed upon changing the connection information as shown in FIG. 14 (Step #206) and it is discriminated whether an instruction has been given to end the editing (Step #207). This routine returns to Step #202 unless such an instruction has been given (NO in Step #207), whereas this routine ends if such an instruction has been given (YES in Step #207).

According to this moving picture file editing routine, upon editing the frame of the moving picture, for example, the frames including the x-th frame being replaced by or changed to blank frames such as blue screen or frames of an other moving picture, the connection information indicating the correspondences between the frames of this moving picture and the still pictures is deleted from the connection information files. Therefore, the connection information can keep matching the correspondences between the moving picture and the still pictures, and the user's confusion caused by the inconsistency of the connection information can be prevented.

Although the items of the connection information file are deleted upon renewing the connection information file during the editing of the moving picture, the connection information file may also be renewed as follows. FIGS. 16A and 16B are tables showing examples of other renewals of the connection information file of FIG. 13.

FIG. 16A shows that the frame number “a” of the moving picture corresponding to the first still picture is so renewed as to become the frame number “a−1” (or “a+1”) of an adjacent frame as the a-th frame of the moving picture is edited. FIG. 16A shows that, as the a-th frame of the moving picture is edited, the frame number “a” of the moving picture corresponding to the first still picture becomes “0”, which means that, although it indicates a correspondence between the moving picture and the first still picture, a correspondence with a specific frame is deleted.

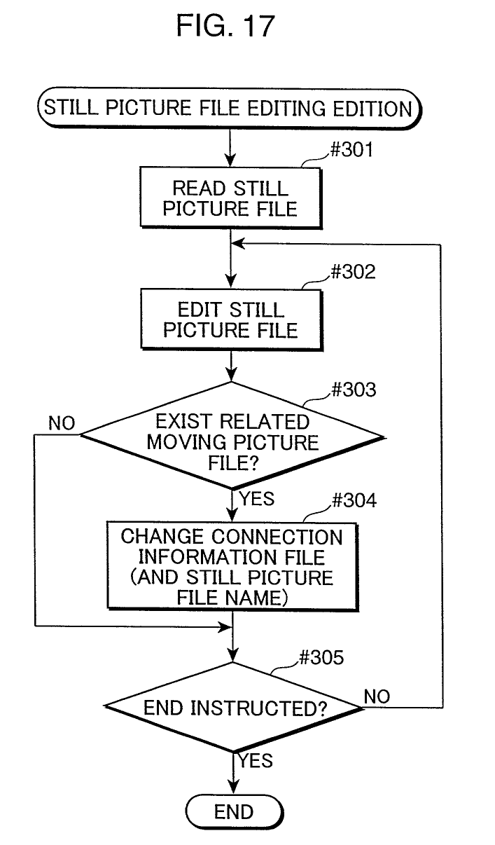

Although the renewal of the connection information file upon editing the moving picture is particularly described above, the connection information file is similarly renewed upon editing the still picture in this image editing apparatus. FIG. 17 is a flowchart showing a procedure of a still picture file editing routine accompanied by a change in the connection information file.

In this still picture file editing routine, all still picture files or still picture file designated by the user in the memory card 108 are read (Step #301), and editing of the read still picture files is received (Step #302).

Upon detecting that the user has edited the still picture, including the identifier “p” in the file name, see FIG. 5, related to the moving picture (Step #303), the connection information file is so renewed that the connection information corresponding to the edited still picture is deleted similar to the renewal shown in FIG. 14, and the name of the still picture file is renewed in such a manner similar to the above that the identifier “p” is changed to an identifier “q” and a new number is given (Step #304). This still picture editing routine returns to Step #302 unless an end of this routine is instructed (NO in Step #305) while ending if it is instructed (YES in Step #305).

In the above routine, the corresponding connection information is deleted from the connection information file as the still picture is edited. However, similar to the connection information file shown in FIG. 16B, the correspondence with the specific frame may be deleted while keeping the correspondence with the moving picture file as the still picture is edited. Further, particularly assuming that the still picture file is to be deleted, the deletion of the still picture file may be accompanied by that of the connection information.

According to this still picture file editing routine, the connection information file can be suitably so renewed as to keep the connection information match the correspondence between the still pictures and the moving picture similarly as the frame of the moving picture is edited as described above.

In the image editing apparatus of this embodiment, the frame number in the connection information is changed by being increased or decreased by one as shown in FIG. 16A as the frame of the moving picture is edited. Alternatively, the frame number may be decreased or increased by a specified number within a range including similar images recorded temporally close to the photographed time of the still picture.

As described above, the moving picture file and the still picture file corresponding to the moving picture are recorded while the connection information indicating the correspondence between the still picture and the section of the moving picture corresponding to the photographing instruction, for example given by pressing the start button down, is recorded. Thus, the user can easily know the correspondence between the moving picture and the still picture by using a specified image editing apparatus and referring to the connection information and can conveniently edit the moving pictures and the still pictures.

Further, since the connection information is stored in the connection information file, the user can conveniently edit the moving pictures and the still pictures while easily handing the connection information by letting the specified image editing apparatus refer to the connection information file.

Further, since addition of the connection information and renewal of the connection information file are properly performed, a plurality of still pictures can be smoothly photographed in response to a plurality of photographing instructions and the above effect can be obtained for a plurality of still pictures corresponding to one moving picture.

Further, if the connection information and the moving picture are stored in one file, the user can more conveniently handle the file.

In the photographing apparatus capable of photographing a still picture even during a non-recording period of a moving picture, the connection information file is recorded only when both the moving picture file and the still picture file are recorded. Thus, the above effect can be obtained without performing a useless operation.

If the connection information file is saved only when the moving picture file is saved, the above effect can be obtained without generating any unnecessary file.

Further, the correspondence between the frame stored in the moving picture file and the still picture stored in the still picture file can be made clear by the connection information or by the information concerning the specified time. Thus, the user can more easily distinguish the correspondences between the moving pictures and the still pictures.

The moving picture file storing the moving picture and the still picture file storing one, two or more still pictures to be photographed in response to the photographing instruction(s) given during recording of the moving picture can be stored in one folder. Thus, the user can more easily administer the moving picture file and the still picture file by using the specified image editing apparatus or the like, and can conveniently edit the moving pictures and the still pictures while easily distinguishing the correspondences between the moving pictures and the still pictures.

The still pictures photographed during the recording period of the moving picture and those photographed during the non-recording period of the moving picture can be stored in different locations using properly hierarchized folders. Thus, the user can obtain the above effects while properly distinguishing the two kinds of still pictures.

Further, if the connection information file is saved in the aforementioned folder, the user can more easily and securely distinguish the correspondences between the moving pictures and the still picture.

The correspondence between the moving picture file storing the moving picture and the still picture file storing the still picture to be photographed in response to the photographing instruction given during recording of the moving picture can be defined by the character string in the file names. Thus, the user can more easily administer and search the moving picture files and the still picture files by using the specified image editing apparatus or the like, and can conveniently edit the moving pictures and the still pictures while easily distinguishing the correspondences between the moving pictures and the still pictures.

The order in which the still pictures were photographed can be discriminated based on the names of the still picture files or the still pictures photographed during the recording period of the moving picture and those photographed during the non-recording period of the moving picture can be distinguished using different identifiers. Thus, the files can be more easily administered and searched.

The moving picture data, the still picture data and the connection information can be stored in the specified three areas of one joint file. Thus, the user can more conveniently administer the files.

Upon editing a specific still image which is one frame image of the moving picture, the connection information in the connection information file indicating the preexisting correspondence between this specific still image and a specified still picture can be automatically deleted or the file name indicating the presence of the correspondence between the specific still image and the specified still image can be suitably changed to a file name indicating the absence of such a correspondence. Thus, the user can conveniently edit the moving picture without needing to edit the connection information. Such a deletion or a change can prevent the user's confusion caused by the inconsistency of the connection information.

Upon editing a specific still image which is one frame image of the moving picture, the correspondence in the connection information between this specific still image and a specified still picture is so renewed as to define a correspondence between this still picture and an other still image different from the specific still image. Thus, the user can conveniently edit the moving picture without needing to edit the connection information.

If a still image recorded temporally close to the specific still image is used as the other still image, the photographed still picture can be corresponded to the suitable still image of the moving picture similar to the original specific still image.

Upon editing a specific still image which is one frame image of the moving picture, the frame number of the specific still image can be deleted from the connection information. Thus, the user can conveniently edit the moving picture while keeping the connection information match the correspondence between the moving picture and the still pictures without needing to edit the connection information. Particularly, since only the frame number is detected, the user can know the correspondence of the still picture and the moving picture from the connection information after the change.

Further, upon editing a still picture corresponded beforehand to a moving picture, the connection information on the edited still picture is deleted from the connection information file or a file name indicating the presence of the correspondence between the still picture and a specific still image of the moving picture is suitably changed to a file name indicating the absence of such a correspondence. Thus, the user can conveniently edit the still picture corresponded beforehand to the moving picture without needing to edit the connection information.

Upon editing a still picture corresponded beforehand to a moving picture, the frame number of a specific still image can be deleted from the connection information. Thus, the user can conveniently edit the still picture corresponded beforehand to the moving picture while keeping the connection information match the correspondence between the moving picture and the still pictures without needing to edit the connection information. Particularly, since only the frame number is detected, the user can know the correspondence of the still picture and the moving picture from the connection information after the change.

As described above, a photographing apparatus comprises an image pickup part which records moving picture and photographs a still picture upon a photographing instruction given during recording of the moving picture; a file recording part which records a moving picture file corresponding to the recorded moving picture and a still picture file corresponding to the photographed still picture; an information recording part which records a connection information indicating a correspondence between a section of the moving picture corresponding to a time of the photographing instruction and the still picture.

A connection information file storing the connection information may be also recorded by the file recording part. In addition, the connection information file may be renewed by adding pieces of connection information corresponding to still pictures newly photographed in response to a plurality of photographing instructions during recording of one moving picture, and the recorded connection information is stored in part of the moving picture file. A still picture file corresponding to a still picture photographed in response to a photographing instruction may be recorded also while no moving picture is recorded, and the connection information file is recorded only when both the moving picture file and the still picture file is recorded.

Further, an input to instruct as to whether or not the stored moving picture file is to be saved is received, and the recorded connection information may be deleted when it is instructed not to save the moving picture file.

It may be assumed that the moving picture file is comprised of a plurality of still image frames; the connection information includes respective names of the moving picture file and the still picture file, and a frame number specifying a still image frame which is a section of the moving picture file corresponding to the still picture.

Alternatively, the connection information may include respective names of the moving picture file and the still picture file, a recording start time and a recording end time of the moving picture, and a period between the recording start time and a time when the instruction is given to photograph the still picture.

A recording control method is adopted in a photographing apparatus for recording a moving picture and photographing a still picture in response to a photographing instruction given during recording of the moving picture.

According to the method, as the moving picture is recorded, a folder is generated in a specified storage for each moving picture, and the moving picture file corresponding to the recorded moving picture and the still picture file corresponding to the photographed still picture are saved in the generated folder.

A storing folder for storing the moving picture file and the still picture file is provided in the storage, and the folder is generated for each moving picture in the storing folder. The still picture file corresponding to the still picture photographed in response to the photographing instruction given during a non-recording period of the moving picture may be recorded outside the generated folder and in the storing folder. Further, the connection information file storing the connection information indicating the correspondence between the still picture and the section of the moving picture corresponding to the time of the photographing instruction may be recorded in the generated folder.

It may be preferable to record the moving picture files corresponding to a plurality of moving pictures to be recorded, and to set the name of the still picture file so as to include a character string which is part of the name of the moving picture file and can distinguish a plurality of moving picture files from each other, and to record the still picture file having the set file name and corresponding to the still picture to be photographed.

The name of the still picture file may be so set as to include a numerical value which varies according to the number of the photographing instructions given during recording of one moving picture. Further, the still picture file may be recorded also to correspond to the still picture photographed in response to the photographing instruction given during the non-recording period of the moving picture. The name of this still picture file may be so set as to include a first identifier in the name of the still picture file when it is photographed during recording of the moving picture while including a second identifier different from the first identifier in the name of the still picture file when the still picture is photographed during the non-recording period of the moving picture.

It may be also preferable to record a moving picture data corresponding to a moving picture to be recorded in a first area of a joint file, a still picture data corresponding to a still picture to be photographed in a second area of the joint file; and a connection information indicating a correspondence between the still picture and a section of the moving picture corresponding to a time of the photographing instruction in a third area of the joint file.

There are provided image editing apparatuses designed to edit still images which are frame images of a moving picture. In the image editing apparatus are recorded a moving picture file storing a moving picture and a connection information file storing a connection information indicating a predetermined correspondence between a specified still picture and a specific one of the still images. When the specific still image is edited, the connection information on this edited specific still image is deleted from the saved connection information file.

In the image editing apparatus, a still picture file corresponding to the still picture and including a first identifier indicating the presence of the correspondence in the file name may further be recorded, and the first identifier is changed to a second identifier indicating the absence of the correspondence as the connection information is deleted.

In another image editing apparatus are recorded a moving picture file storing a moving picture and a connection information file storing a connection information indicating a predetermined correspondence between a specified still picture and a specific one of the still images. When the specific still image is edited, the correspondence concerning the edited specific still image in the recorded connection information file is so renewed as to define a correspondence between the specified still picture and an other still image different from the specific still image.

In this image editing apparatus, the other still image may be a still image recorded temporally close to the specific still image.

In still another image editing apparatus are recorded a moving picture file storing a moving picture and a connection information file storing a connection information including the name of the moving picture file, the name of a still picture file storing a still picture corresponding to a specific one of still images consisting of the moving picture, and a frame number of the specific still image of the moving picture. When the specific still image is edited, the frame number in the recorded connection information file is deleted.

Further, there are provided image editing apparatuses designed to edit a still picture having a predetermined correspondence with a specific one of still images which are frame images of a moving picture.

In further another image editing apparatus are recorded a still picture file storing a still picture and a connection information file storing a connection information indicating a predetermined correspondence between the still picture and the specific still image. When the specific still image is edited, the connection information on this edited specific still image is deleted from the recorded connection information file.

In this image editing apparatus, the name of the still picture file may include a first identifier indicating the presence of the correspondence, and the first identifier may be changed to a second identifier indicating the absence of the correspondence as the connection information is deleted.

In yet further image editing apparatus are recorded a moving picture file storing a moving picture, a still picture file storing a still picture related to the moving picture and a connection information file storing a connection information indicating the name of the moving picture file, the name of the still picture file, and a frame number of the specific still image of the moving picture. When the specific still image is edited, the frame number in the saved connection information file is deleted.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A photographing apparatus comprising:
an image pickup part which records a moving picture and photographs a still picture upon a photographing instruction given during recording of the moving picture;
a file recording part which records a moving picture file corresponding to the recorded moving picture and a still picture file corresponding to the photographed still picture; and
an information recording part which records a connection information indicating a correspondence between a section of the moving picture corresponding to a time of the photographing instruction and the still picture.

2. A photographing apparatus according to claim 1, wherein the file recording part records a connection information file storing the connection information.

3. A photographing apparatus according to claim 2, wherein the connection information file is renewed by adding pieces of connection information corresponding to still pictures newly photographed in response to a plurality of photographing instructions during recording of one moving picture.

4. A photographing apparatus according to claim 2, wherein the connection information is stored in part of the moving picture file.

5. A photographing apparatus according to claim 2, wherein the file recording part records a still picture file corresponding to a still picture photographed in response to a photographing instruction while no moving picture is recorded, and the connection information file is recorded only when both the moving picture file and the still picture file is recorded.

6. A photographing apparatus according to claim 2, further comprising:
an input part which receives instruction as to whether or not the recorded moving picture file is to be saved; and
a deletion part which deletes the recorded connection information when it is instructed not to save the moving picture file.

7. A photographing apparatus according to claim 1, wherein the moving picture file includes a plurality of still image frames, and the connection information includes respective names of the moving picture file and the still picture file, and a frame number specifying a still image frame which is a section of the moving picture file corresponding to the still picture.

8. A photographing apparatus according to claim 1, wherein the connection information includes respective names of the moving picture file and the still picture file, a recording start time and a recording end time of the moving picture, and a period between the recording start time and a time when the instruction is given to photograph the still picture.

9. A method for controlling recording of a moving picture and a still picture, comprising the steps of:
recording a moving picture;
generating a folder in a specified storage for each moving picture as the moving picture is recorded;
saving in a generated folder a moving picture file;
photographing a still picture in response to a photographing instruction given during recording of the moving picture; and
saving in a generated folder a still picture file corresponding to the photographed still picture.

10. A method according to claim 9, wherein the storage is provided with a storing folder for storing the moving picture file and the still picture file, and the folder for each moving picture is generated in the storing folder, and the still picture file corresponding to the still picture photographed in response to the photographing instruction given during a non-recording period of the moving picture is recorded in the storing folder and outside the generated folder.

11. A method according to claim 9, further comprising the step of recording a connection information file storing a connection information indicating a correspondence between the still picture and the section of the moving picture corresponding to the time of the photographing instruction in the generated folder.

12. A method according to claim 9, further comprising the step of setting name of the still picture file so as to include a character string which is part of name of the moving picture file and distinguish a plurality of moving picture files from one another.

13. A method according to claim 12, wherein the name of the still picture file is so set as to include a numerical value which varies according to the number of photographing instructions given during recording of one moving picture.

14. An image editing apparatus for editing still images which are frame images of a moving picture, the apparatus comprising:
a memory which stores a moving picture file storing a moving picture, and a connection information file storing a connection information indicating a predetermined correspondence between a specified still picture and a specific one of the still images;
a memory controller which renews a connection information on an edited specific still image of the saved connection information file, when the specific still image is edited.

15. An image editing apparatus according to claim 14, wherein the memory controller defines a correspondence between the specified still picture and a still image different from the specific still image.

16. An image editing apparatus according to claim 14, wherein the memory controller deletes the connection information on the edited specific still image from the saved connection information file.

17. An image editing apparatus according to claim 14, wherein the connection information file includes a frame number of the specific still image in the moving picture, and the memory controller deletes the frame number of the edited specific still image.

18. An image editing apparatus according to claim 14, wherein the connection information file includes name of the moving picture file, name of the still picture file storing a still picture corresponding to the specific still image, and a frame number specifying the specific still image in the moving picture.

19. An image editing apparatus according to claim 14, wherein the memory stores a still picture file including a first identifier indicating the correspondence to the specific still image in the file name, and the first identifier is changed to a second identifier indicating absence of the correspondence as the connection information is deleted.

20. An image editing apparatus according to claim 14, wherein the other still image is near to the specific still image in the term of time.
